(19) United States
(12) Patent Application Publication
(10) Pub. No.: US 2013/0093745 A1
(43) Pub. Date: Apr. 18, 2013

(54) DISPLAY PANELS AND DISPLAY UNITS THEREOF

(71) Applicants: Chih-Jen CHEN, Tainan City (TW); Chien-Chih HSU, Miaoli County (TW)

(72) Inventors: Chih-Jen CHEN, Tainan City (TW); Chien-Chih HSU, Miaoli County (TW)

(73) Assignee: INDUSTRIAL TECHNOLOGY RESEARCH INSTITUTE, Hsinchu (TW)

(21) Appl. No.: 13/368,311

(22) Filed: Feb. 7, 2012

(30) Foreign Application Priority Data
Oct. 17, 2011 (TW) TW100137472

(51) Int. Cl. G09G 5/00; G09G 3/36

(52) U.S. Cl. 345/212; 345/98

(57) ABSTRACT

A display unit is provided. The display unit includes a multiplexer circuit, a latch circuit, and a liquid crystal capacitor. The multiplexer circuit receives a plurality of voltages. The plurality of voltages at least comprises a first voltage and a second voltage. The latch circuit receives a driving signal and a first data signal. When the driving signal is at an asserted state, the latch circuit controls the multiplexer circuit according to the first data signal to select the first voltage or the second voltage to serve as a display voltage. The liquid crystal capacitor receives the display voltage. The liquid crystal capacitor has a plurality of liquid crystal molecules, and an optical state of the plurality of liquid crystal molecules is determined according to the display voltage.

### CROSS REFERENCE TO RELATED APPLICATIONS

This Application claims priority of Taiwan Patent Application No. 100137472, filed on Oct. 17, 2011, the entirety of which is incorporated by reference herein.

### BACKGROUND

1. Field of the Disclosure

The disclosure relates to a display panel, and more particularly to a cholesteric liquid crystal (Ch-LC) display panel which comprises display units with a new circuitry structure for increasing an image refresh rate.

2. Description of the Related Art

Among the current display panels developed, paper-like display panels are popular. A cholesteric liquid crystal (Ch-LC) display panel is one type of paper-like display panel and has some characteristics, such as having a bi-stable state, low power consumption, colorization, and low cost. However, since Ch-LC molecules of a Ch-LC display panel have a low impedance characteristic, the voltage-holding ratio (VHR) of a display panel is affected disadvantageously, such that the operating life span of a display panel may be decreased.

Thus, assume that it is desired to provide a liquid crystal display panel comprising new display units to hinder the disadvantageous affects for the VHR and increase an image refresh rate.

### SUMMARY

An exemplary embodiment of a display unit comprises a multiplexer circuit, a latch circuit, and a liquid crystal capacitor. The multiplexer circuit receives a plurality of voltages. The plurality of voltages at least comprises a first voltage and a second voltage. The latch circuit receives a driving signal and a first data signal. When the driving signal is at an asserted state, the latch circuit controls the multiplexer circuit according to the first data signal to select the first voltage or the second voltage to serve as a display voltage. The liquid crystal capacitor receives the display voltage. The liquid crystal capacitor has a plurality of liquid crystal molecules, and an optical state of the plurality of liquid crystal molecules is determined according to the display voltage.

In an embodiment, when the driving signal is switched to be at a de-asserted state from the asserted state, the latch circuit continuously controls the multiplexer circuit to select the first voltage or the second voltage, which is selected when the driving signal is at the asserted state, to serve as the display voltage.

An exemplary embodiment of a display panel operates during a plurality of frame periods for displaying images. The display panel comprises a plurality of first data lines, a plurality of scan lines, and a plurality of display units. The plurality of first data lines are arranged sequentially and transmit a plurality of first data signals, respectively. The plurality of scan lines are arranged sequentially and interlaced with the plurality of first data signals. The plurality of scan lines transmits a plurality of driving signals, respectively. During each of the plurality of frame periods, the driving signals are at an asserted state sequentially. The plurality of display units are arranged in a plurality of rows and a plurality of columns. Each of the plurality of display units corresponds to one set of the interlaced first data line and scan line, and the display units arranged in the same row are coupled to the same scan line. Each of the plurality of display units comprises a multiplexer circuit, a latch circuit, and a liquid crystal capacitor. The multiplexer circuit receives a plurality of voltages. The plurality of voltages at least comprises a first voltage and a second voltage. The latch circuit is coupled to the corresponding first data line for receiving the corresponding first data signal and coupled to the corresponding scan line for receiving the corresponding driving signal. During each of the plurality of frame periods, when the corresponding driving signal is at the asserted state, the latch circuit controls the multiplexer circuit according to the corresponding first data signal to select the first voltage or the second voltage to serve as a display voltage. The liquid crystal capacitor receives the display voltage. The liquid crystal capacitor has a plurality of liquid crystal molecules, and an optical state of the plurality of liquid crystal molecules is determined according to the display voltage.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 shows an exemplary embodiment of a display panel;

FIG. 2 shows an exemplary embodiment of a display unit;

FIG. 3 is a diagram showing timings of main signals of a display unit according to an exemplary embodiment;

FIG. 4 shows another exemplary embodiment of a display panel;

FIG. 5 shows another exemplary embodiment of a display unit;

FIG. 6 shows relationships between reflectance of cholesteric liquid crystal (Ch-LC) molecules and magnitude of a voltage applied to the Ch-LC molecules;

FIGS. 7A and 7B are diagrams showing the timings of main signals of a display unit according to an exemplary embodiment when the display unit is designed to be switched between Planar State and Homeotropic State;

FIG. 8 shows further another exemplary embodiment of a display panel;

FIG. 9 shows another exemplary embodiment of a display unit; and

FIGS. 10A and 10B are diagrams showing the timings of main signals of a display unit according to another exemplary embodiment when the display unit is designed to be switched between Planar State and Homeotropic State.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

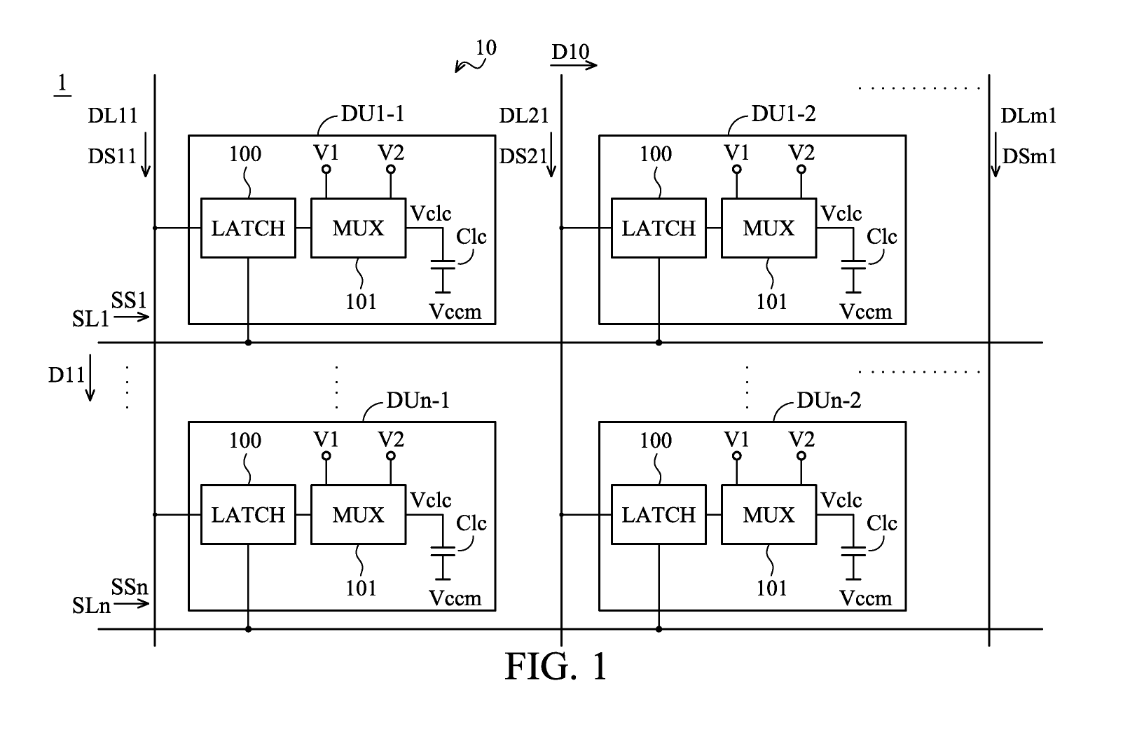

Display panels are provided. In an exemplary embodiment of a display panel in FIG. 1, a display panel 1 operates during a plurality of frame periods for displaying images and comprises a plurality of data lines DL11˜DLm1, a plurality of scan lines SL1˜SLn, and a plurality of display units DU. The data lines DL11˜DLm1 are arranged sequentially in a direction D10 and transmit data signals DS11˜DSm1 respectively. The scan lines SL1˜SLn are arranged sequentially in a direction D11 and transmit driving signals SS1˜SSn respectively. According to the directions D10 and D11, the scan lines SL1˜SLn are interlaced with the data lines DL11˜DLm1. The display units are arranged in a display array 10 formed by n rows and m columns. Each display unit corresponds to one set of the interlaced scan line and data line. The display units arranged in the same row are coupled to the same scan line. For example, the display unit DU1-1 corresponds to the interlaced scan line SL1 and data line DL11, the display unit DU1-2 corresponds to the interlaced scan line SL1 and data line DL21, the display unit DUn-1 corresponds to the interlaced scan line SLn and data line DL11, and the display unit DUn-2 corresponds to the interlaced scan line SLn and data line DL21. The display units DU1-1 and DU1-2 and the other display units arranged in the same row are coupled to the scan line SL1.

Referring to FIG. 1, each display unit comprises a latch circuit (LATCH) 100, a multiplexer circuit (MUX) 101, and a liquid crystal capacitor Clc. In the following description, the display unit DU1-1 is given as an example to illustrate the circuitry structure of the display units. In the display unit DU14-1, the latch circuit 100 is coupled to the corresponding data line DL11 and the corresponding scan line SL1. The multiplexer circuit 101 receives a plurality of voltages. In the embodiment, two voltages V1 and V2 received by the multiplexer circuit 101 are given as an example. During each frame period, when the driving signal SS1 transmitted by the scan line SL1 is at an asserted state, the latch circuit 100 controls the multiplexer circuit 101 according to the data signal DS11 transmitted by the data line DL11 to select one voltage (the voltage V1 or V2), and the selected voltage serves as a display voltage Vclc which is provided to the liquid crystal capacitor Clc. An optical state of liquid crystal molecules in the liquid crystal capacitor Clc is determined according to the display voltage Vclc. Moreover, during each frame period, when the driving signal SS1 is switched to be at a de-asserted state from the asserted state, the latch circuit 111 continuously controls the multiplexer circuit 101 to select the voltage V1 or V2 which has been selected when the driving signal SS1 is at the asserted state to serve as the display voltage Vclc. Accordingly, the liquid crystal molecules in the liquid crystal capacitor Clc can remain at the previous optical state until the next frame period starts.

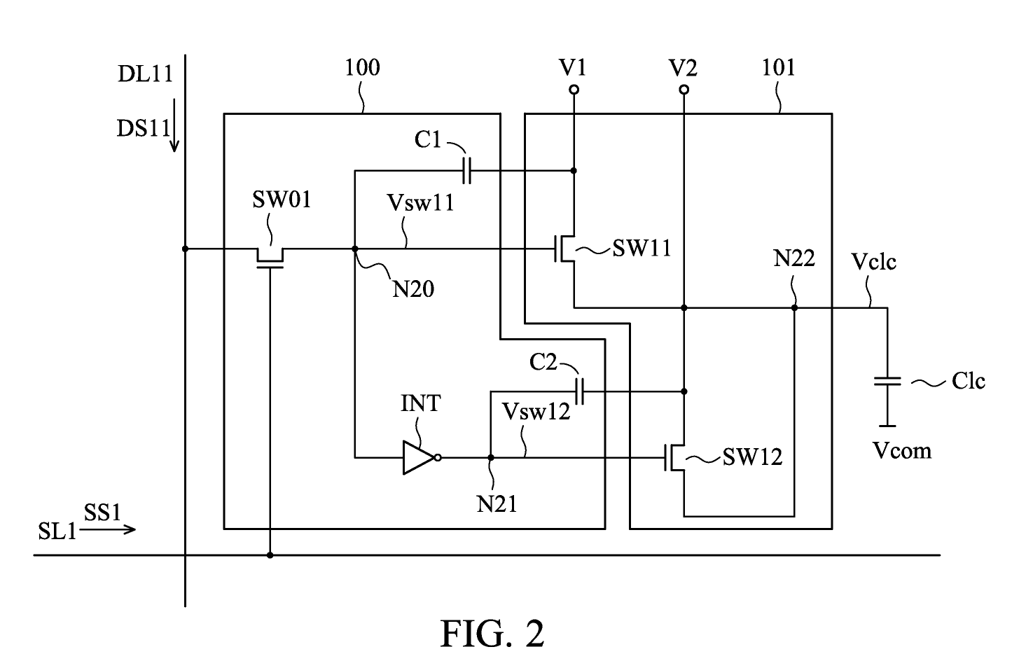

FIG. 2 shows an exemplary embodiment of a display unit. In the following description, the display unit DU1-1 is given as an example to illustrate the detailed circuit of the display units, and the other display units have the same circuit as the display unit DU1-1. Referring to FIG. 2, the latch circuit 100 comprises a switch Sw01, an inverter INT, and capacitors C1 and C2. A control terminal of the switch SW01 is coupled to the scan line SL1 to receive the driving signal SS, an input terminal thereof is coupled to the data line DL11 to receive the data signal DS11, and an output terminal thereof is coupled to a node N20. In the embodiment, the switch SW01 is implemented by an N-type metal oxide semiconductor (NMOS) transistor. The control terminal, the input terminal, and the output terminal of the switch correspond to the gate, the drain, and the source of the NMOS transistor, respectively. In the following description, the corresponding relationship between the terminals of the switch and the electrodes of the NMOS transistor is also applied to switches implemented by NMOS transistors. Thus, related description is omitted. The inverter INT is coupled between the node N20 and a node N21. The capacitor C1 is coupled between the voltage V1 and the node N20, and the capacitor C2 is coupled between the voltage V2 and the node N21.

The multiplexer circuit 101 comprises switches SW11 and SW12. In the embodiment, both of the switches SW11 and SW12 are implemented by NMOS transistors. The gate of the NMOS transistor SW11 is coupled to the node N20, the drain thereof is coupled to the voltage V1, and the source thereof is coupled to the liquid crystal capacitor Clc at a node N22. The gate of the NMOS transistor SW12 is coupled to the node N21, the drain thereof is coupled to the voltage V2, and the source thereof is coupled to the node N22. The liquid crystal capacitor Clc is coupled between the node N22 and a common voltage Vcom.

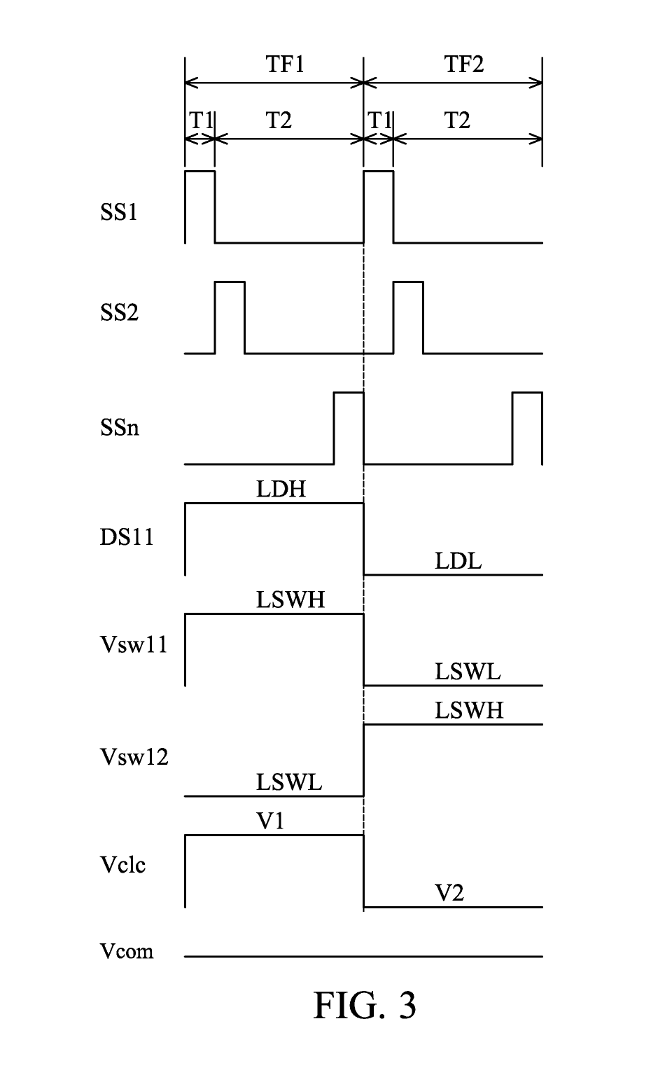

FIG. 3 is a diagram showing the timings of main signals of the display unit DU1-1. The circuit operation of the display unit D1-1 is illustrated by referring to FIGS. 2 and 3. Referring to FIG. 3, during each frame period TF, the driving signals SS1˜SSn are asserted sequentially. In other words, the driving signals SS1˜SSn are at the asserted state sequentially. In the embodiment, the asserted state of the driving signal represents that the driving signal is at a relative high voltage level, and the de-asserted state of the driving signal represents that the driving signal is at a relative low voltage level.

During the frame period TF1, when the driving signal SS1 is at the asserted state in the period T1, the NMOS transistor SW01 is turned on according to the driving signal SS 1 with the high voltage level. At this time, the data signal DS11 is transmitted to the node N20 through the turned-on NMOS transistor SW01. Referring to FIG. 3, during the frame period TF1, the data signal DS11 has a high voltage level LDH. In the embodiment, the high voltage level LDH of the data signal DS11 is higher than the levels of the voltages V1 and V2. Thus, when the NMOS transistor SW01 is tuned on, a gate voltage Vsw11 of the NMOS transistor SW11 has a high voltage level LSWH according to the high voltage level LDH of the data signal DS11. At this time, the NMOS transistor SW11 is turned on according to the gate voltage Vsw11 with the high voltage level LSWH, and the gate voltage Vsw11 with the high voltage level LSWH charges the capacitor C1. The inverter INT performs an inverse operation to the data signal DS11. Accordingly, a gate voltage Vsw12 of the NMOS transistor SW12 has a low voltage level LSWL to turn off the NMOS transistor SW12. The gate voltage Vsw12 with the low voltage level LSWL charges the capacitor C2. Since the NMOS transistor SW11 is turned on and the NMOS transistor SW12 is turned off, the voltage V1 is transmitted to the node N22 through the turned-on NMOS transistor SW11 to serve as the display voltage Vclc. The optical state of liquid crystal molecules in the liquid crystal capacitor Clc is changed according to the voltage V1. That is, the voltage V1 determines the optical state of liquid crystal molecules.

In a period T2 following the period T1 during the frame period TF1, the driving signal SS1 is switched to be at the de-asserted state from the asserted state. The NMOS transistor SW01 is turned off according to the driving signal SS1 with the low voltage level. At this time, through the charging of the capacitors C1 and C2 in the period T1, the gate voltage Csw11 remains at the high voltage level LSWH and the gate voltage Vsw12 remains at the low voltage level LSWL according to the charges in the capacitors C1 and C2. In other words, the voltage V1 are continuously transmitted to the node N22 through the turned-on NMOS transistor SW11 to serve as the display voltage Vclc, so that liquid crystal molecules in the liquid crystal capacitor Clc remain at the optical state which has been determined by the voltage V1 in the period T1.

During the following frame period TF2, when the driving signal SS1 is at the asserted state in the period T1, the NMOS transistor SW01 is turned on according to the driving signal SS1 with the high voltage level. Referring to FIG. 3, during the frame period TF2, the data signal DS11 has a low voltage level LDL. In the embodiment, the low voltage level LDL of the data signal DS11 is lower than the levels of the voltages V1 and V2. Thus, when the NMOS transistor SW01 is tuned on, the gate voltage Vsw11 of the NMOS transistor SW11 has the low voltage level LSWL according to the low voltage level LDL of the data signal DS11. At this time, the NMOS transistor SW11 is turned off according to the gate voltage Vsw11 with the low voltage level LSWL, and the gate voltage Vsw11 with the low voltage level LSWL charges the capacitor C1. The inverter INT performs the inverse operation to the data signal DS11. Accordingly, the gate voltage Vsw12 of the NMOS transistor SW12 has the high voltage level LSWH to turn on the NMOS transistor SW12. The gate voltage Vsw12 with the high voltage level LSWH charges the capacitor C2. Since the NMOS transistor SW11 is turned off and the NMOS transistor SW12 is turned on, the voltage V2 is transmitted to the node N22 through the turned-on NMOS transistor SW12 to serve as the display voltage Vclc. The optical state of liquid crystal molecules in the liquid crystal capacitor Clc is changed according to the voltage V2. That is, the voltage V2 determines the optical state of liquid crystal molecules.

In a period T2 following the period T1 during the frame period TF2, the driving signal SS1 is switched to be at the de-asserted state from the asserted state. The NMOS transistor SW01 is turned off according to the driving signal SS1 with the low voltage level. At this time, through the charging of the capacitors C1 and C2 in the period T1, the gate voltage Csw11 remains at the low voltage level LSWL and the gate voltage Vsw12 remains at the high voltage level LSWH according to the charges in the capacitors C1 and C2. In other words, the voltage V2 are continuously transmitted to the node N22 through the turned-on NMOS transistor SW12 to serve as the display voltage Vclc, so that the liquid crystal molecules in the liquid crystal capacitor Clc remain at the optical state which has been determined by the voltage V2 in the period T1.

According to the embodiment of the display panel, for each display unit, during one frame period, since the capacitors C1 and C2 memorize the gate voltages Vsw11 and Vsw12 of the NMOS transistors SW11 and SW12, when the corresponding driving signal is switched to be at the de-asserted state, the NMOS transistors SW11 and SW12 can be continuously at the respective turned-on/turned-off states in the period T2. Thus, the voltage V1 or V2 can be continuously transmitted to the liquid crystal capacitor Clc, and the liquid crystal molecules in the liquid crystal capacitor Clc can remain at the optical state, thereby increasing the voltage-holding ratio (VHR) of the display panel 1. Moreover, due to the memorization operation of the capacitors C1 and C2 to the gate voltages Vsw1 and Vsw12, the period T1 when each driving signal is at the asserted state is shortened. As a whole, each frame period is shortened, thereby increasing the image refresh rate of the display panel.

In the embodiment of FIGS. 1 and 2, the display panel 1 drives the display units of the display array 10 without adopting any inversion operation. Thus, the common voltage Vcom has a fixed level. In another embodiment, the display panel 1 may drive the display units of the display array 10 by adopting an inversion operation, such as line inversion, frame inversion, etc. In this case, the common voltage Vcom does not remain at a fixed level, and, contrarily, the common voltage Vcom is switched between a high voltage level and a low voltage level. In the following embodiments, the display panel 1 drives the display units of the display array 10 without adopting any inversion operation for illustration.

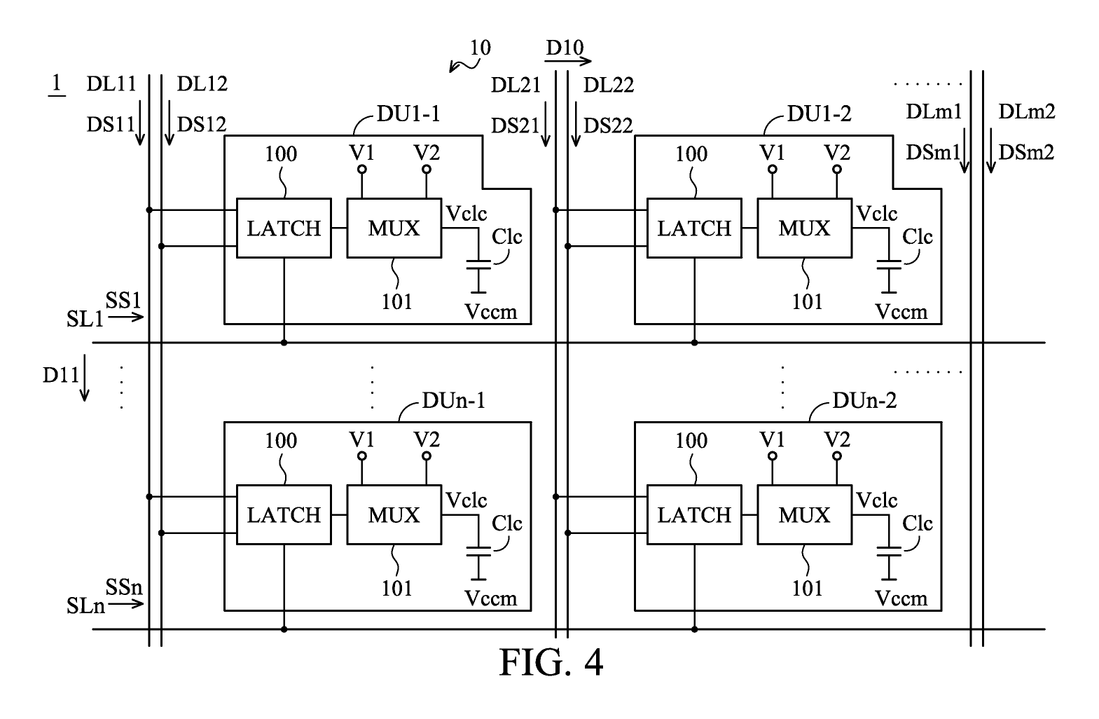

FIG. 4 shows another exemplary embodiment of a display panel. In FIGS. 1 and 4, the same element is labeled by the same reference sign. Referring to FIGS. 1 and 4, the difference is that the display panel 1 in FIG. 4 further comprises a plurality of data lines DL12˜DLm2 corresponding to the data lines DL11˜DLm1, respectively. The data lines DL12˜DLm2 are arranged sequentially in the direction D10 and transmit data signals DS12˜DSm2, respectively. In the embodiment of FIG. 4, the data signals DS 12˜DSm2 are inverse to the corresponding data signals DS11˜DSm1. For example, when the data signal DS12 has a high voltage level LDH, the corresponding data signal DS 11 has a low voltage level LDL. In the display array 10, each display unit DU corresponds to one set of one scan line and two data lines interlaced with the one scan line. For example, the display unit DU1-1 corresponds to the interlaced scan line SL1 and data lines DL11 and DL12. The display unit DU1-1 is given as an example for the following description. Compared with the display panel of FIG. 1, the difference is that, during each frame period of the display panel of FIG. 4, when the scan signal SS1 transmitted by the scan line SL1 is at the asserted state, the latch circuit 100 controls the multiplexer circuit 101 according to not only the data signal DS11 transmitted by the data line DL11 but also the data signal DS12 transmitted by the data line DL12 to select the voltage V1 or V2 to serve as the display voltage Vclc.

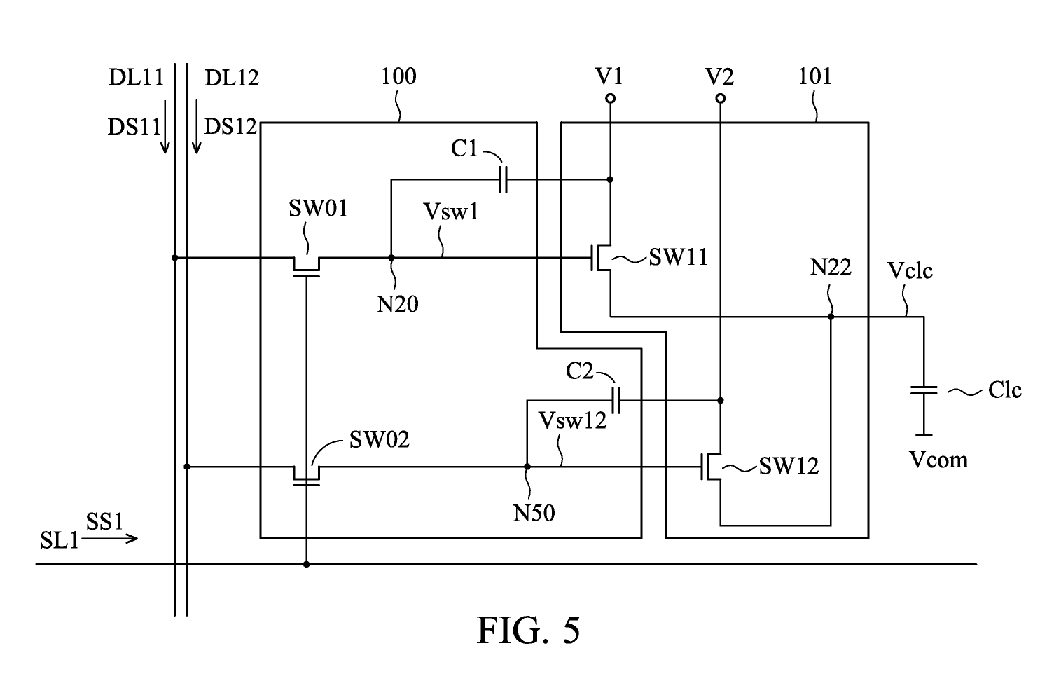

FIG. 5 shows another exemplary embodiment of a display unit. In the following description, the display unit DU1-1 is given as an example to illustrate the detailed circuit of the display units, and the other display units have the same circuit as the display unit DU1-1. In FIGS. 2 and 5, the same element is labeled by the same reference sign. Referring to FIGS. 2 and 5, the difference is that the latch circuit 100 of FIG. 5 further comprises a switch SW02. The switch SW02 is implemented by an NMOS transistor. A gate of the NMOS transistor SW02 is coupled to the scan line SL1 to receive the driving signal SS1, a drain thereof is coupled to the data line DL12 to receive the data signal DS12, and a source thereof is coupled to a node N50. Since the latch circuit 100 of FIG. 5 does not comprises the inverter INT of FIG. 2, the capacitor C2 is modified to be coupled between the voltage V2 and the node N50. In the multiplexer circuit 101, due to the addition of the NMOS transistor SW02 and the removal of the inverter INT, the gate of the NMOS transistor SW12 is modified to be coupled to the node N50.

The operation of the NMOS transistor SW02 is the same as the operation of the NMOS transistor SW01, thus related description is omitted. Moreover, the operations of the other elements are the same as those in the embodiment of FIG. 2 described above.

According to the above description, in the display panel of FIG. 4, the data lines DL12˜DLm2 transmit the data signals DS12˜DSm2 inverse to the data signals DS11˜DSm1. Thus, the inverters INT in the display units of FIG. 2 are omitted, thereby reducing the area of the display array 10.

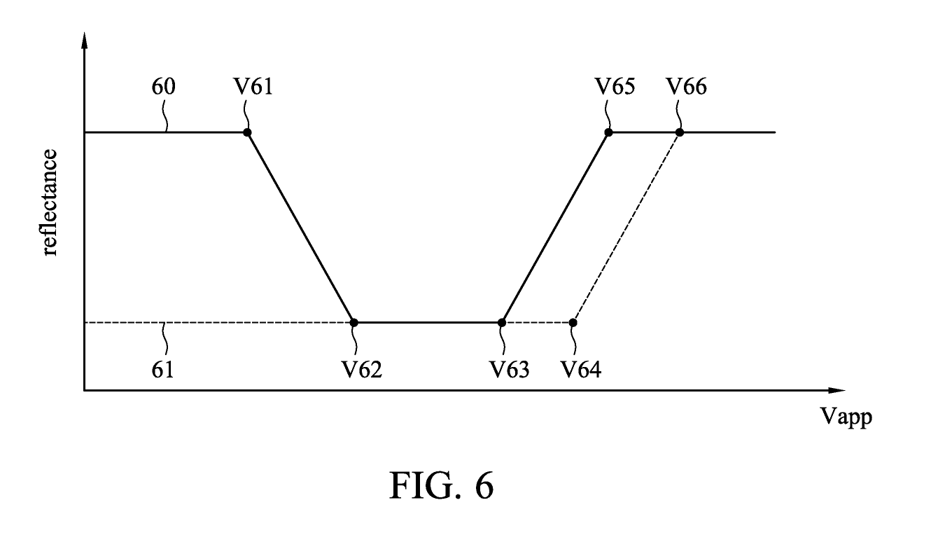

In the embodiment, the molecules in the liquid crystal capacitor Clc are cholesteric liquid crystal (Ch-LC) molecules. The magnitude of the voltages V1 and V2 may be determined according to the bright optical state and the dark optical state of the Ch-LC molecules. FIG. 6 shows relationships between reflectance of Ch-LC molecules and magnitude of a voltage Vapp applied to the Ch-LC molecules. Referring to FIG. 6, the curve 60 represents relationships between the reflectance and the magnitude of the applied voltage Vapp when the Ch-LC molecules are initially at a Planar State (bright state), and the curve 61 represents relationships between the reflectance and the magnitude of the applied voltage Vapp when the Ch-LC molecules are initially at a Focal Conic State (dark state).

According to the curve 60, when the voltage applied Vapp to the Ch-LC molecules is less than a voltage V61, the Ch-LC molecules remain at a Planar State. When the applied voltage Vapp increases to be between voltages V62 and V63, the Ch-LC molecules are switched to be at a Focal Conic State, and the reflectance decreases. After the applied voltage Vapp is stopped from being provided, the Ch-LC molecules remain at the Focal Conic State. When the applied voltage Vapp continuously increases to be larger than a voltage V65, the Ch-LC molecules are switched to be at a Homeotropic State (dark state). After the applied voltage Vapp is stopped from being provided, the Ch-LC molecules are switched to be at a Planar State. As shown in FIG. 6, the curve 60 shows a left slope driving operation and a right slope driving operation to drive the Ch-LC molecules.

According to the curve 61, when the applied voltage Vapp is less than a voltage V64, the Ch-LC molecules remain at the Focal Conic State. When the applied voltage Vapp increases to a voltage V66, the Ch-LC molecules are switched to be at a Homeotropic State. After the applied voltage Vapp is stopped from being provided, the Ch-LC molecules are switched to be at a Planar State.

Thus, according to the above description, in the embodiment, if each display unit is designed to be switched between a Planar State (bright state) and Homeotropic State (dark state), the value of one of the voltages V1 and V2 is set to be larger than the voltage V65 (about 40V), and the voltage of the other one is set to be less than the voltage V60 (about 0V). For example, in an embodiment, the voltage V1 is set to be larger than V2. Accordingly, the value of the voltage V1 is set to be lager than the voltage V65, while the value of the voltage V2 is set less than the voltage V61.

According to the above description, if each display unit is designed to be switched between a Planar State and Homeotropic State, the value of the voltage V1 is fixed and equal to about 40V. In another embodiment, if each display unit is designed to be switched between a Planar State (bright state) and Focal Conic State (dark state), the value of the voltage V1 is set to be switched between 40V and 20V, while the value of the voltage V2 is still fixed and equal to above 0V.

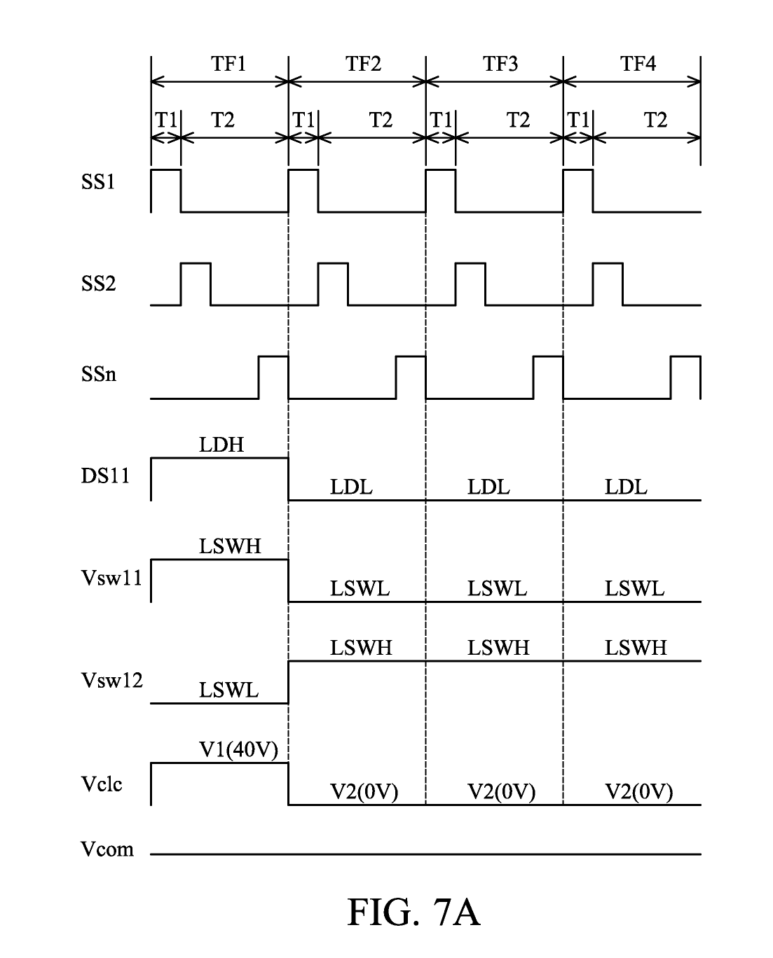

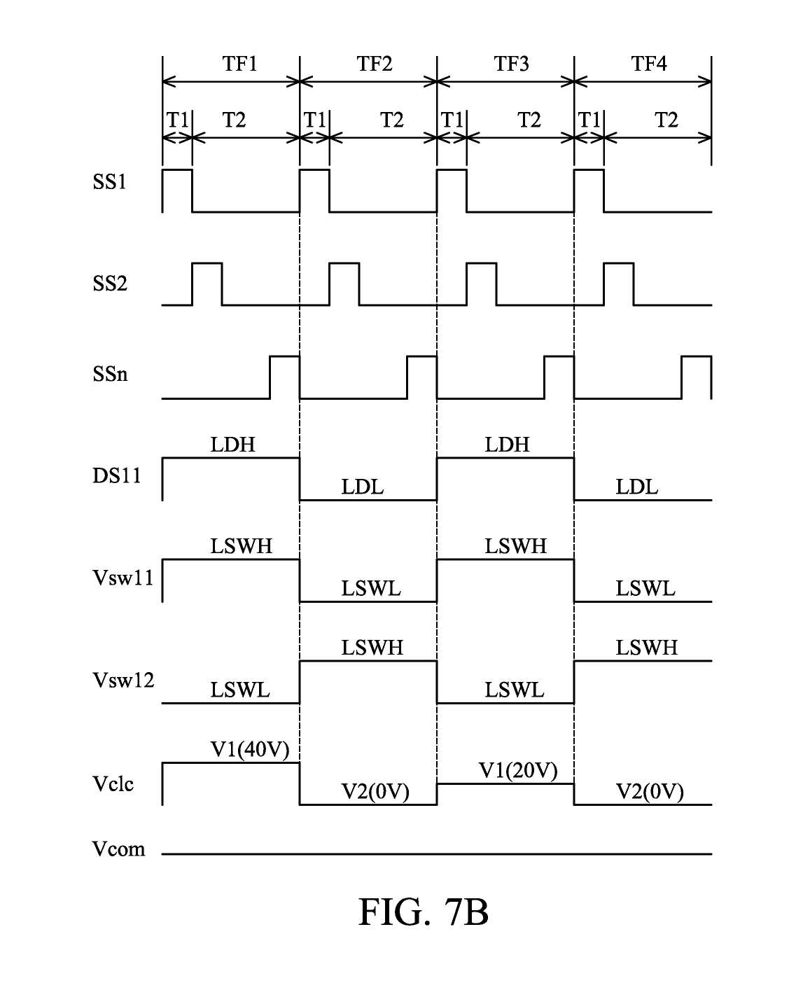

According to the characteristics of the Ch-LC molecules, when the display units are switched between a Planar State and Focal Conic State, the display units require passing through four periods: a reset period, a relaxing period, an addressing period, and a discharging period. Referring to FIG. 7A, the frame periods TF1, TF2, TF3, and TF4 correspond to the reset period, the relaxing period, the addressing period, and the discharging period, respectively. In the following description, the display unit DU1-1 is given as an example, and the left slope driving operation is used to drive the display unit DU1-1. According to FIG. 7A, assume that it is desired to drive the display unit DU1-1 to be at a Planar State, the multiplexer circuit 101 selects the voltage V1 to serve as the display voltage Vclc during the frame period TF1. At this time, the value of the voltage V1 is equal to 40V, so that the Ch-LC molecules in the liquid crystal capacitor Clc are at a Homeotropic State. Then, during the frame periods TF2˜TF4, the multiplexer circuit 101 is switched to select the voltage V2 to serve as the display voltage Vclc, so that the Ch-LC molecules in the liquid crystal capacitor Clc are at a Planar State. Thus, finally, the display unit DU1-1 is at a Planar state.

According to FIG. 7B, assume that it is desired to drive the display unit DU1-1 to be at a Focal Conic State, the multiplexer circuit 101 selects the voltage V1 to serve as the display voltage Vclc during the frame period TF1. At this time, the value of the voltage V1 is equal to 40V, so that the Ch-LC molecules in the liquid crystal capacitor Clc are at a Homeotropic State. During the frame period TF2, the multiplexer circuit 101 selects the voltage V1 to serve as the display voltage Vclc, so that the Ch-LC molecules in the liquid crystal capacitor Clc are at a Planar state. Then, during the frame period TF3, the multiplexer circuit 101 selects the voltage V1 to serve as the display voltage Vclc. At this time, the value of the voltage V1 is switched to be equal to 20V, so that the Ch-LC molecules in the liquid crystal capacitor Clc are at a Focal Conic state. During the frame period TF4, the multiplexer circuit 101 is switched to select the voltage V2 to serve as the display voltage Vclc, so that the Ch-LC molecules in the liquid crystal capacitor Clc are still at a Focal Conic state. Thus, the display unit DU1-1 finally is at a Focal Conic state.

In the above embodiments, the multiplexer circuit 101 continuously selects the voltage V1 to serve as the display voltage Vclc during the frame period TF3. In another embodiment, the frame period TF3 is divided into a plurality of sub-frame periods. In some of the sub-frame periods, the multiplexer circuit 101 selects the voltage V1 equal to 20V to serve as the display voltage Vclc. In some other of the sub-frame periods, the multiplexer circuit 101 selects the voltage V2 to serve as the display voltage Vclc. Accordingly, one portion of the Ch-LC molecules in the liquid crystal capacitor Clc is at the Focal Conic State, and the other portion thereof is at a Planar State, thereby accomplishing gray-level displaying. The level of the gray-level displaying is determined according to the number of sub-frame periods when the voltage V2 is selected by the multiplexer circuit 101 and the number of sub-frame periods when the voltage V1 is selected by the multiplexer circuit 101. In other words, the level of the gray-level displaying is determined according to the number of Ch-LC molecules being at the Focal Conic State and the number of Ch-LC molecules being at a Planar State.

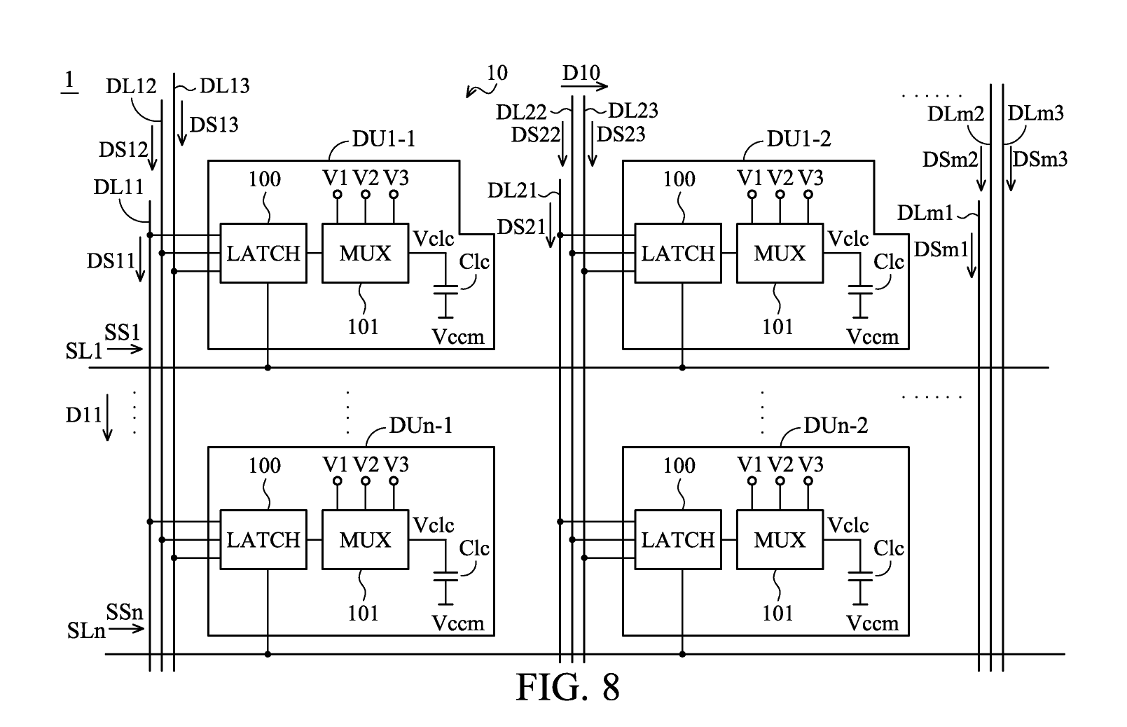

In the above embodiments, for each display unit, the multiplexer circuit 101 receiving two voltages V1 and V2 is given as an example. According to the above description, if each display unit is desired to be switched between a Planar State and Focal Conic State, the value of the voltage V1 is set to be switched between 40V and 20V, and the value of the voltage is set to be equal to 0V. Thus, each display unit requires three voltage values 0V, 20V, and 40V for the switching between a Planar State and Focal Conic State. In another embodiment, the multiplexer circuit 101 may receives three voltages with different values, and, thus, the value of the voltage V1 is not required to be switched between 20V and 40V. FIG. 8 shows another exemplary embodiment of a display panel. Referring to FIGS. 1 and 8, the difference is that the display panel 1 of FIG. 8 further comprises a plurality of data lines DL12˜DLm1 and DL13˜DLm3. The data lines DL12˜DLm2 correspond to the data lines DL11˜DLm1, respectively, and the data lines DL13˜DLm3 also correspond to the data lines DL11˜DLm1, respectively. The data lines DL12˜DLm2 are arranged sequentially in the direction D10 and transmit data signals DS12˜DSm2, respectively. The data lines DL13˜DLm3 are arranged sequentially in the direction D10 and transmit data signals DS13˜DSm3, respectively. In the display array 10, each display unit DU corresponds to one set of one scan line and three data lines interlaced with the one scan line. For example, the display unit DU1-1 corresponds to the interlaced scan line SL1 and data lines DL11, DL12, and DL13.

In the embodiment, each display unit receives three voltages V1, V2, and V3. The value of the voltage V1 is set to equal to about 40V, the value of the voltage V2 is set to equal to about 0V, and the value of the voltage V3 is set to equal to about 20V. In the following description, the display unit SU1-1 is given as an example. During each frame period, when the driving signal SS1 transmitted by the scan line SL1 is at the asserted state, the latch circuit 100 controls the multiplexer circuit 101 according to the data signals DS11, DS12, and DS13 to select one voltage (the voltage V1, V2, or V3) to serve as the display voltage Vclc of the liquid crystal capacitor Clc. The optical state of the Ch-LC molecules in the liquid crystal capacitor Clc is determined according to the display voltage Vclc. Moreover, during each frame period, when the driving signal SS1 is switched to be at a de-asserted state from the asserted state, the latch circuit 111 continuously controls the multiplexer circuit 101 to select the voltage V1, V2, or V3 which has been selected when the driving signal SS1 is at the asserted state to serve as the display voltage Vclc. Accordingly, the liquid crystal molecules in the liquid crystal capacitor Clc can remain at the previous optical state until the next frame period starts.

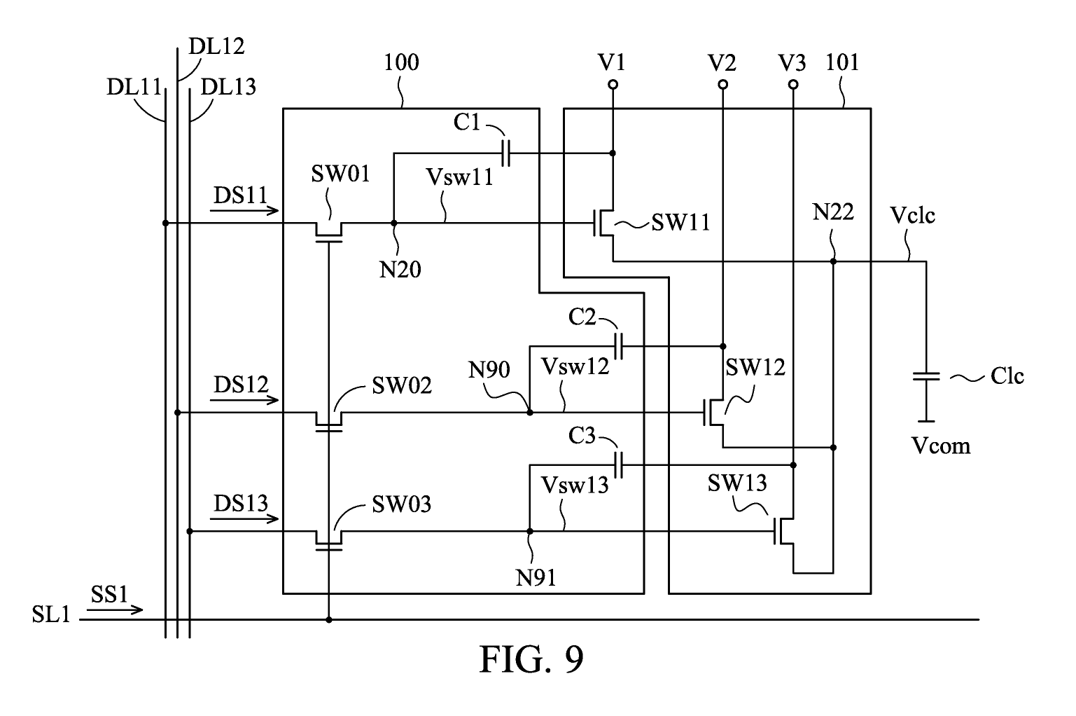

FIG. 9 shows another exemplary embodiment of a display unit. In the following description, the display unit DU1-1 is given as an example to illustrate the detailed circuit of the display units, and the other display units have the same circuit as the display unit DU1-1. In FIGS. 2 and 9, the same element is labeled by the same reference sign. In FIG. 9, the display unit DU1-1 corresponds to the data lines DL11, D112, and DL13, and the multiplexer circuit 101 of the display unit Du1-1 receives the voltages V1, V2, and V3. Accordingly, the latch circuit 100 of FIG. 9 does not comprise the inverter INT. The latch circuit 100 of FIG. 9 further comprises the switches SW02 and SW03, and the multiplexer circuit 101 further comprises a switch SW13. Each of the switches SW02, SW03, and SW13 is implemented by an NMOS transistor.

In the latch circuit 100, a gate of the NMOS transistor SW02 is coupled to the scan line SL1 to receive the driving signal SS1, a drain thereof is coupled to the data line DL12 to receive the data signal DS12, and a source thereof is coupled to a node N90. A gate of the NMOS transistor SW03 is coupled to the scan line SL1 to receive the driving signal SS1, a drain thereof is coupled to the data line DL13 to receive the data signal DS13, and a source thereof is coupled to a node N91. The capacitor C2 is coupled between the voltage V2 and the node N90. The capacitor C3 is coupled between the voltage V3 and the node N91. The operations of the NMOS transistors SW02 and SW03 are the same as the operation of the NMOS transistor SW01 described above, thus related description is omitted.

In the multiplexer circuit 101, the gate of the NMOS transistor SW12 is coupled to the node N90. A gate of the NMOS transistor SW13 is coupled to the node N91, a drain thereof receives the voltage V3, and a source thereof is coupled to the node N22. The operation of the NMOS transistor SW13 is the same as the operations of the NMOS transistors SW11 and SW13 described above, thus related description is omitted.

According to the circuitry structure of the display unit of FIG. 9, the latch circuit 100 controls the multiplexer circuit 101 according to the data signals DS11, DS12, and DS13 to select the voltage V1, V2, or V3 to serve as the display voltage Wk.

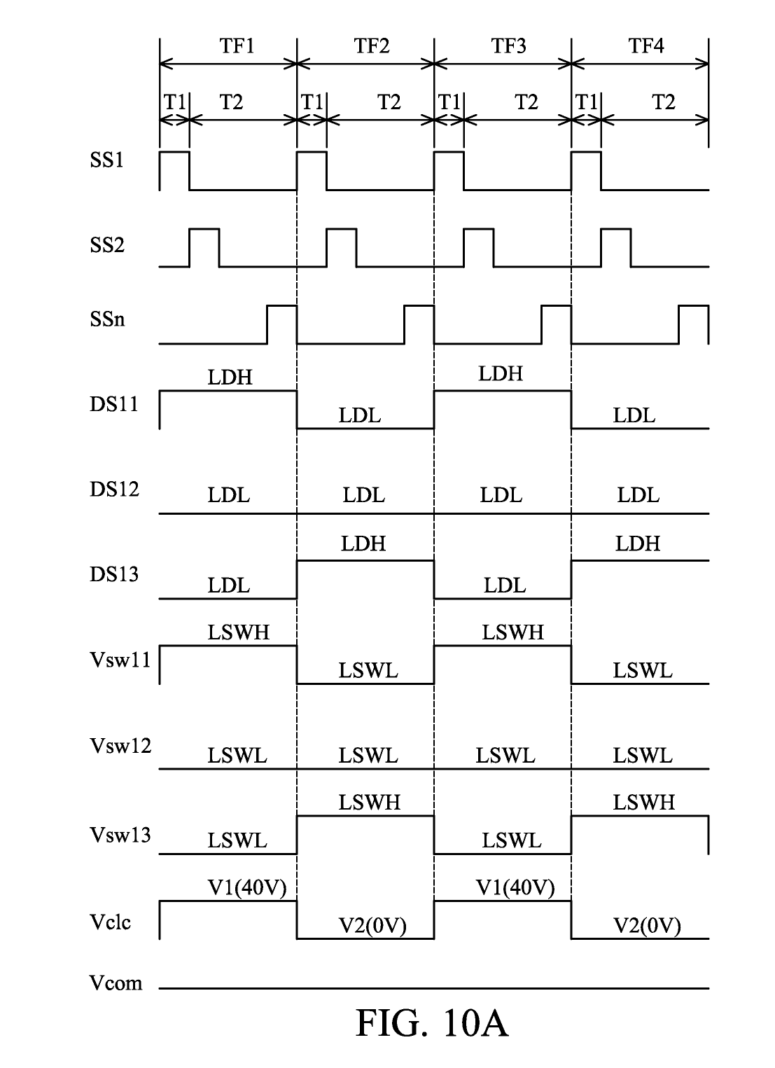

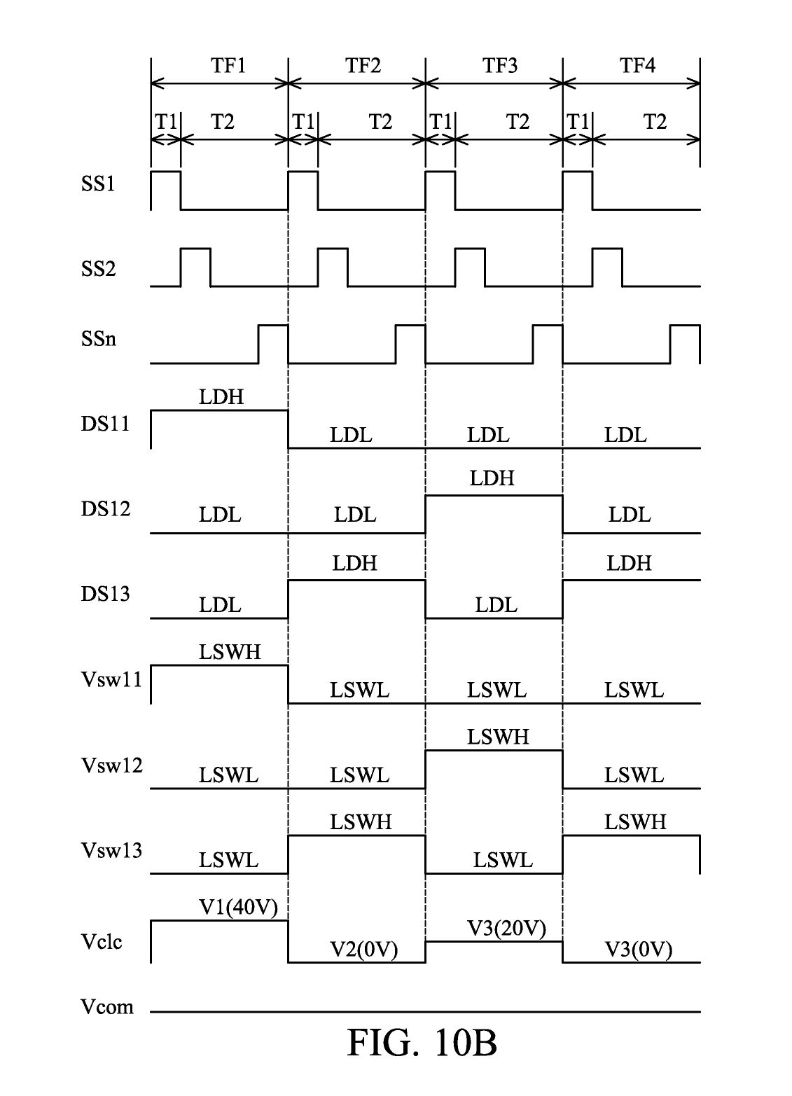

As described above, according to the characteristic of the Ch-LC molecules, when the display units are switched between a Planar State and Focal Conic State, the display units require passing through four periods: a reset period, a relaxing period, an addressing period, and a discharging period. Referring to FIG. 10A, the frame periods TF1, TF2, TF3, and TF4 correspond to the reset period, the relaxing period, the addressing period, and the discharging period, respectively. In the following description, the display unit DU1-1 is given as an example, and the right slope driving operation is used to drive the display unit DU1-1. According to FIG. 10A, assume that it is desired to drive the display unit DU1-1 to be at a Planar State. During the frame period TF1, the NMOS transistor SW11 is turned on according to the gate voltage Vsw11 with the high voltage level LSWH, while the NMOS transistors SW12 and SW12 are turned off according to the gate voltages Vsw12 and Vsw13 with the low voltage level LSWL, respectively. Thus, during the frame period TF1, the multiplexer circuit 101 selects the voltage V1 to serve as the display voltage Vclc, so that the Ch-LC molecules in the liquid crystal capacitor Clc are at a Homeotropic State. During the frame period TF2, the NMOS transistor SW12 is turned on, while the NMOS transistors SW11 and SW13 are turned off. Thus, the multiplexer circuit 101 selects the voltage V2 to serve as the display voltage Vclc, so that the Ch-LC molecules in the liquid crystal capacitor Clc are at a Planar State. Then, during the frame period TF3, the NMOS transistor SW11 is turned on, while the NMOS transistors SW12 and SW13 are turned off. The multiplexer circuit 101 selects the voltage V1 again to serve as the display voltage Vclc, so that the Ch-LC molecules in the liquid crystal capacitor Clc are at a Homeotropic State. During the frame period TF4, the NMOS transistor SW12 is turned on, while the NMOS transistors SW11 and SW13 are turned off. Thus, the multiplexer circuit 101 selects the voltage V2 to serve as the display voltage Vclc, so that the Ch-LC molecules in the liquid crystal capacitor Clc are at a Planar State. Thus, the display unit DU1-1 is at a Planar State finally.

According to FIG. 10B, assume that it is desired to drive the display unit DU1-1 to be at a Focal Conic State. During the frame period TF1, the multiplexer circuit 101 selects the voltage V1 to serve as the display voltage Vclc, so that the Ch-LC molecules in the liquid crystal capacitor Clc are at a Homeotropic State. During the frame period TF2, the multiplexer circuit 101 selects the voltage V2 to serve as the display voltage Vclc, so that the Ch-LC molecules in the liquid crystal capacitor Clc are at a Planar State. Then, during the frame period TF3, the multiplexer circuit 101 selects the voltage V3 to serve as the display voltage Vclc, so that the Ch-LC molecules in the liquid crystal capacitor Clc are at a Focal Conic State. During the frame period TF4, the multiplexer circuit 101 selects the voltage V2 to serve as the display voltage Vclc, so that the Ch-LC molecules in the liquid crystal capacitor Clc are still at a Focal Conic State. Thus, the display unit DU1-1 is finally at a Focal Conic State.

While the disclosure has been described by way of example and in terms of the preferred embodiments, it is to be understood that the disclosure is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A display unit comprising:
a multiplexer circuit for receiving a plurality of voltages, wherein the plurality of voltages at least comprises a first voltage and a second voltage;
a latch circuit for receiving a driving signal and a first data signal, wherein when the driving signal is at an asserted state, the latch circuit controls the multiplexer circuit according to the first data signal to select the first voltage or the second voltage to serve as a display voltage; and
a liquid crystal capacitor for receiving the display voltage, wherein the liquid crystal capacitor has a plurality of liquid crystal molecules, and an optical state of the plurality of liquid crystal molecules is determined according to the display voltage.

2. The display unit as claimed in claim 1, wherein when the driving signal is switched to be at a de-asserted state from the asserted state, the latch circuit continuously controls the multiplexer circuit to select the first voltage or the second voltage, which is selected when the driving signal is at the asserted state, to serve as the display voltage.

3. The display unit as claimed in claim 1, wherein the latch circuit comprises:
a first switch having a control terminal receiving the driving signal, an input terminal receiving the first data signal, and an output terminal coupled to a first node;
an inverter coupled between the first node and a second node;
a first capacitor coupled between the first voltage and the first node; and
a second capacitor coupled between the second voltage and the second node.

4. The display unit as claimed in claim 3, wherein the multiplexer circuit comprises:
second switch having a control terminal coupled to the first node, an input terminal coupled to the first voltage, and an output terminal coupled to the liquid crystal capacitor at a third node; and
a third switch having a control terminal coupled to the second node, an input terminal coupled to the second voltage, and an output terminal coupled to the third node.

5. The display unit as claimed in claim 4, wherein the liquid crystal capacitor is coupled between the third node and a common voltage.

6. The display unit as claimed in claim 1,
wherein the latch circuit further receives a second data signal, and when the driving signal is at the asserted state, the latch circuit controls the multiplexer circuit according to the first data signal and the second data signal to select the first voltage or the second voltage to serve as a display voltage, and
wherein when the driving signal is switched to be at a de-asserted state from the asserted state, the latch circuit continuously controls the multiplexer circuit to select the first voltage or the second voltage, which is selected when the driving signal is at the asserted state, to serve as the display voltage.

7. The display unit as claimed in claim 6, wherein the latch circuit comprises:
a first switch having a control terminal receiving the driving signal, an input terminal receiving the first data signal, and an output terminal coupled to a first node;
a second switch having a control terminal receiving the driving signal, an input terminal receiving the second data signal, and an output terminal coupled to a second node;
a first capacitor coupled between the first voltage and the first node; and
a second capacitor coupled between the second voltage and the second node.

8. The display unit as claimed in claim 7, wherein the multiplexer circuit comprises:
a third switch having a control terminal coupled to the first node, an input terminal coupled to the first voltage, and an output terminal coupled to the liquid crystal capacitor at a third node; and
a fourth switch having a control terminal coupled to the second node, an input terminal coupled to the second voltage, and an output terminal coupled to the third node.

9. The display unit as claimed in claim 8, wherein the liquid crystal capacitor is coupled between the third node and a common voltage.

10. The display unit as claimed in claim 1, wherein the plurality of liquid crystal molecules are cholesteric liquid crystal (Ch-LC) molecules.

11. The display unit as claimed in claim 10,
wherein a value of the first voltage is larger than a value of the second voltage,
wherein when the multiplexer circuit selects the first voltage to serve as the display voltage, the plurality of liquid crystal molecules are at a Homeotropic State according to the first voltage, and
wherein when the multiplexer circuit selects the second voltage to serve as the display voltage, the plurality of liquid crystal molecules are at a Planar State according to the second voltage.

12. The display unit as claimed in claim 10, wherein
wherein during a reset period, the multiplexer circuit selects the first voltage to serve as the display voltage, and the plurality of liquid crystal molecules are at a Homeotropic State according to the first voltage,
wherein during a relaxing period following the reset period, the multiplexer circuit selects the second voltage to serve as the display voltage, and the plurality of liquid crystal molecules are at a Planar State according to the second voltage,
wherein during an addressing period following the relaxing period, the multiplexer circuit selects the first voltage to serve as the display voltage, and the plurality of liquid crystal molecules are at a Focal Conic State according to the first voltage, and
wherein during a discharging period following the addressing period, the multiplexer circuit selects the second voltage to serve as the display voltage, and the plurality of liquid crystal molecules are at the Focal Conic State according to the second voltage

13. The display unit as claimed in claim 12,
wherein a value of the second voltage is equal to 0V; and
wherein a value of the first voltage is equal to 40V during the reset period, and the value of the first voltage is equal to 20V during the addressing period.

14. A display panel operating during a plurality of frame periods for displaying images, comprising:
a plurality of first data lines, arranged sequentially, for transmitting a plurality of first data signals, respectively;
a plurality of scan lines, arranged sequentially and interlaced with the plurality of first data signals, for transmitting a plurality of driving signals, respectively, wherein during each of the plurality of frame periods, the driving signals are at an asserted state sequentially; and
a plurality of display units arranged in a plurality of rows and a plurality of columns, wherein each of the plurality of display units corresponds to one set of the interlaced first data line and scan line, and the display units arranged in the same row are coupled to the same scan line,
wherein each of the plurality of display units comprises:
multiplexer circuit for receiving a plurality of voltages, wherein the plurality of voltages at least comprises a first voltage and a second voltage;
a latch circuit coupled to the corresponding first data line for receiving the corresponding first data signal and coupled to the corresponding scan line for receiving the corresponding driving signal, wherein during each of the plurality of frame periods, when the corresponding driving signal is at the asserted state, the latch circuit controls the multiplexer circuit according to the corresponding first data signal to select the first voltage or the second voltage to serve as a display voltage; and
a liquid crystal capacitor for receiving the display voltage, wherein the liquid crystal capacitor has a plurality of liquid crystal molecules, and an optical state of the plurality of liquid crystal molecules is determined according to the display voltage.

15. The display panel as claimed in claim 14, wherein for each of the plurality of display units, during each of the plurality of frame period, when the driving signal is switched to be at a de-asserted state from the asserted state, the latch circuit continuously controls the multiplexer circuit to select the first voltage or the second voltage, which is selected when the driving signal is at the asserted state, to serve as the display voltage.

16. The display panel as claimed in claim 14, wherein for each of the plurality of display units, the latch circuit comprises:
a first switch having a control terminal coupled to the corresponding scan line for receiving the corresponding driving signal, an input terminal coupled to the corresponding first data line for receiving the corresponding first data signal, and an output terminal coupled to a first node;
inverter coupled between the first node and a second node;
a first capacitor coupled between the first voltage and the first node; and
a second capacitor coupled between the second voltage and the second node.

17. The display panel as claimed in claim 16, wherein for each of the plurality of display units, the multiplexer circuit comprises:
a second switch having a control terminal coupled to the first node, an input terminal coupled to the first voltage, and an output terminal coupled to the liquid crystal capacitor at a third node; and
a third switch having a control terminal coupled to the second node, an input terminal coupled to the second voltage, and an output terminal coupled to the third node.

18. The display panel as claimed in claim 17, wherein for each of the plurality of display units, the liquid crystal capacitor is coupled between the third node and a common voltage.

19. The display panel as claimed in claim 14 further comprising:
a plurality of second data lines, arranged sequentially, for transmitting a plurality of second data signals, respectively,
wherein the plurality of scan lines are interlaced with the plurality of first data lines and the plurality of second data lines, and each of the plurality of display units corresponds to one set of the interlaced first data line, second data line, and scan line;
wherein, for each of the plurality of display units, the latch circuit is further coupled to the corresponding second data line for receiving the corresponding second data signal, and during each of the plurality of frame periods, when the corresponding driving signal is at the asserted state, the latch circuit controls the multiplexer circuit according to the corresponding first data signal and the corresponding second data signal to select the first voltage or the second voltage to serve as a display voltage, and
wherein, for each of the plurality of display units, during each of the plurality of frame periods, when the corresponding driving signal is switched to be at a de-asserted state from the asserted state, the latch circuit continuously controls the multiplexer circuit to select the first voltage or the second voltage, which is selected when the corresponding driving signal is at the asserted state, to serve as the display voltage.

20. The display panel as claimed in claim 19, wherein for each of the plurality of display units, the latch circuit comprises:
a first switch having a control terminal coupled to the corresponding scan line for receiving the corresponding driving signal, an input terminal coupled to the corresponding first data line for receiving the corresponding first data signal, and an output terminal coupled to a first node;
a second switch having a control terminal coupled to the corresponding scan line for receiving the corresponding driving signal, an input terminal coupled to the corresponding second data line for receiving the corresponding second data signal, and an output terminal coupled to a second node;
a first capacitor coupled between the first voltage and the first node; and
a second capacitor coupled between the second voltage and the second node.

21. The display panel as claimed in claim 20, wherein for each of the plurality of display units, the multiplexer circuit comprises:
a third switch having a control terminal coupled to the first node, an input terminal coupled to the first voltage, and an output terminal coupled to the liquid crystal capacitor at a third node; and
fourth switch having a control terminal coupled to the second node, an input terminal coupled to the second voltage, and an output terminal coupled to the third node.

22. The display panel as claimed in claim 21, wherein the liquid crystal capacitor is coupled between the third node and a common voltage.

23. The display panel as claimed in claim 14, wherein the plurality of liquid crystal molecules are cholesteric liquid crystal (Ch-LC) molecules.
